(19) United States
(12) Patent Application Publication
(10) Pub. No.: US 2014/0159522 A1
(43) Pub. Date: Jun. 12, 2014

(54) DC Motor Assembly and Method

(71) Applicant: Twin-Star International, Inc., Delray Beach, FL (US)

(72) Inventors: Matthew Crowe, Chelsea (CA); Dong Zhi Xu, Dongguan City (CN)

(73) Assignee: TWIN-STAR INTERNATIONAL, INC., Delray Beach, FL (US)

(21) Appl. No.: 13/707,388

(22) Filed: Dec. 6, 2012

(51) Int. Cl. H02K 7/10; H02K 7/116

(52) U.S. Cl. CPC H02K 7/1004; H02K 7/116
USPC 310/80

(57) ABSTRACT

An assembly is presented that can be used in an electric fireplace for providing rotational motion. The assembly can be used to drive an auxiliary axle with extensions to simulate a flickering flame. The assembly may include a direct current (DC) motor to create an initial rotational motion about an input axle at an input rate. The DC motor may be driven by a variable electric voltage that is variable. The assembly also includes a transmission to convert the rotational motion from the input axle at the input rate to an output axle at an output rate. The transmission uses pulleys, belts, and optionally gears to convert the rotational motion from the input rate to the output rate.

### FIELD OF THE INVENTION

The invention relates to an apparatus that provides rotational motion. More particularly, the invention relates to an apparatus that provides rotational motion using a direct current motor and a transmission.

### BACKGROUND

Motors are typically used to convert electrical energy into mechanical energy. A common configuration of the electric motor uses magnetism to create rotational motion. Current passed through the electric motor is used to generate a first magnetic field. A second magnetic field may interact with the first magnetic field, causing a rotor to rotate as portions of the rotor are attracted to and repulsed by various portions of the stator.

Electric motors are available in a number of configurations, which may operate under different physical principles. For example, motors can be configured to operate using either alternating current (AC) or direct current (DC). Motors using alternating current may operate as synchronously or asynchronously relative to the frequency of the alternating line current, as with a synchronous or induction motor, respectively. Motors operating by direct current may periodically reverse the flow direction of electrical current relative to the speed of rotation, providing different operating characteristics from an alternating current motor.

Synchronous AC motors may be used in consumer devices due their ability to operate on electrical current drawn from a wall outlet, without the need for a conversion from AC to DC. However AC motors can be noisier than their direct current counterparts, making their use impractical where quiet operation is desired. Also, the rate of rotational motion provided by an AC motor is not easily variable, creating a level of inflexibility in systems using AC motors. Alternatively, DC motors often provide rotational motion at a high rate, which may make the DC motor impractical for some applications.

What is needed is an assembly for a DC motor to provide rotational motion to an attached device at a desired rate. What is also needed is a transmission included with the assembly to convert an input rate of rotational motion to an output rate of rotational motion, which may drive a connected device. What is also needed is a transmission configured to operate substantially silently and with high efficiency.

### SUMMARY

The present invention is related to an assembly that can be used in an electric fireplace for providing rotational motion. The assembly may include a direct current (DC) motor to create an initial rotational motion about an input axle at an input rate. The DC motor may be driven by a variable electric voltage. The assembly may also include a transmission to convert the rotational motion from the input axle at the input rate to an output axle at an output rate. The transmission uses pulleys, belts, and optionally gears to convert the rotational motion from the input rate to the output rate.

According to the embodiments of the present invention, a DC motor assembly is described that may provide rotational motion to an attached device at a desired rate. The DC motor assembly may also include a transmission to convert an input rate of rotational motion to an output rate of rotational motion, which may drive a connected device. The DC motor assembly may be configured to operate substantially silently and with high efficiency.

In one aspect, an assembly is provided that may be included in an electric fireplace. The assembly may be used for providing rotational motion. The assembly may include a direct current (DC) motor to create an initial rotational motion about an input axle at an input rate. The DC motor may be driven by an electric voltage that is variable. Additionally, the assembly may include a transmission to convert the rotational motion from the input axle at the input rate to an output axle at an output rate. The transmission may further include pulleys and a belt to convert the rotational motion from the input rate to the output rate. The motor and the transmission may be operatively connected to a bracket.

In another aspect, the assembly with the bracket, motor and transmission may be located in the electric fireplace. An auxiliary axle may be connected to the output axle to be rotated at the output rate. Extensions may be positioned about the auxiliary axle to simulate flames in the electric fireplace.

In another aspect, the transmission may further include a first, second, third, and fourth pulley. The first pulley may be attached the input axle. The second pulley may be attached to the first pulley axle. The second pulley may have a larger diameter than the first pulley. The second pulley may be operatively connected to the first pulley via a first belt. The third pulley may be attached to the first pulley axle. The third pulley may have a smaller diameter than the second pulley. The fourth pulley attached to the output axle. The fourth pulley may have a larger diameter than the third pulley. The fourth pulley may be operatively connected to the third pulley via a second belt.

In another aspect, along with the previous aspect, the transmission may additionally include a first and second gear. Also, the fourth pulley may be attached to a second pulley axle. The first gear may also be attached to the second pulley axle. A second gear may be attached to the output axle, the second gear having a larger diameter than the first gear. The second gear may be operated by the first gear.

In another aspect, the transmission may the rotational motion at a ratio of approximately 1:20, 1:60, or 1:80.

In another aspect, the DC motor may be driven by the electric voltage that is variable between approximately two volts and six volts. The variation of the electric voltage may affect the input rate of the rotational motion that is converted by the transmission to the output rate of about 10-50 revolutions per minute (RPM).

In another aspect, the input voltage may be approximately three volts and the output rotational motion may be approximately 15-18 RPM.

According to another embodiment, in one aspect, an assembly is disclosed for providing rotational motion. The assembly may include a direct current (DC) motor to create an initial rotational motion about an input axle at an input rate. The DC motor may be driven by an electric voltage that is variable between two and six volts. The assembly may also include a transmission to convert the rotational motion from the input axle at the input rate to an output axle at an output rate. The transmission may include pulleys and a belt to convert the rotational motion from the input rate to the output rate. The variation of the electric voltage may affect the input rate of the rotational motion that is converted by the transmission to the output rate of approximately 10-50 revolutions per minute (RPM).

In another aspect, the motor and transmission maybe operatively connected to a bracket positioned in the electric fireplace. An auxiliary axle may be connected to the output axle to be rotated at the output rate. Extensions may be positioned about the auxiliary axle to simulate flames in the electric fireplace.

In another aspect, the transmission may further include a first, second, third, and fourth pulley. The first pulley may be attached the input axle. The second pulley may be attached to the first pulley axle. The second pulley may have a larger diameter than the first pulley. The second pulley may be operatively connected to the first pulley via a first belt. The third pulley may be attached to the first pulley axle. The third pulley may have a smaller diameter than the second pulley. The fourth pulley attached to the output axle. The fourth pulley may have a larger diameter than the third pulley. The fourth pulley may be operatively connected to the third pulley via a second belt.

In another aspect, along with the previous aspect, the transmission may additionally include a first and second gear. Also, the fourth pulley may be attached to a second pulley axle. The first gear may also be attached to the second pulley axle. A second gear may be attached to the output axle, the second gear having a larger diameter than the first gear. The second gear may be operated by the first gear.

In another aspect, the transmission may convert the rotational motion at a ratio of approximately 1:20, 1:60, or 1:80.

In another aspect, the input voltage may be approximately three volts, and wherein the output rotational motion may be approximately 15-18 RPM.

A method aspect is provided for creating rotational motion in an electric fireplace using a direct current (DC) motor and a transmission. The method may include the step of driving the DC motor with an electric voltage to create an initial rotational motion about an input axle at an input rate, the electric voltage being is variable. The method may also include converting the rotational motion from the input axle at the input rate to an output axle at an output rate using the transmission, wherein the transmission further comprises pulleys and a belt to convert the rotational motion from the input rate to the output rate. The motor and the transmission may be operatively connected to a bracket locatable in the electric fireplace.

In another aspect, the bracket with the motor and the transmission may be located in the electric fireplace. In this aspect, the method may further include the steps of rotating an auxiliary axle that is connected to the output axle at the output rate and rotating extensions positioned about the auxiliary axle to simulate flames in the electric fireplace.

In another aspect, the conversion of rotational motion by the transmission may further include rotating a first pulley attached the input axle. The method may also include driving a first belt using the first pulley to rotate a second pulley attached to a first pulley axle, the second pulley having a larger diameter than the first pulley. Additionally, the method may include rotating a third pulley attached to the first pulley axle, the third pulley having a smaller diameter than the second pulley. The method may further include driving a second belt using the third pulley to rotate a fourth pulley attached to the output axle, the fourth pulley having a larger diameter than the third pulley.

In another aspect, the conversion of rotational motion by the transmission may include rotating a first pulley attached the input axle. The method may also include driving a first belt using the first pulley to rotate a second pulley attached to a first pulley axle, the second pulley having a larger diameter than the first pulley. Additionally, the method may include rotating a third pulley attached to the first pulley axle, the third pulley having a smaller diameter than the second pulley. The method may include driving a second belt using the third pulley to rotate a fourth pulley attached to a second pulley axle, the fourth pulley having a larger diameter than the third pulley. The method may also include rotating a first gear attached to the second pulley axle. The method may further include rotating a second gear attached to the output axle and operatively connected to the first gear, the second gear having a larger diameter than the first gear.

In another aspect, the transmission may convert the rotational motion at a ratio of approximately 1:20, 1:60, or 1:80.

In another aspect, the DC motor may be driven by the electric voltage that is variable between approximately two volts and six volts. The variation of the electric voltage may affect the input rate of the rotational motion that is converted by the transmission to the output rate of about 10-50 revolutions per minute (RPM).

In another aspect, the input voltage may be approximately three volts, and wherein the output rotational motion may be approximately 15-18 RPM.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a perspective view of the assembly, according to an embodiment of the present invention.

FIG. 2 is a rear elevation view of the assembly, according to an embodiment of the present invention.

FIG. 3 is a front elevation view of the assembly with a transmission of pulleys, according to an embodiment of the present invention.

FIG. 4 is a side elevation view of the embodiment illustrated in FIG. 3.

FIG. 5 is an exploded view of the embodiment illustrated in FIG. 3.

FIG. 6 is a flowchart illustrating the operation of the embodiment illustrated in FIG. 3.

FIG. 7 is a front elevation view of the assembly with a transmission of pulleys, according to an embodiment of the present invention.

FIG. 8 is a side elevation view of the embodiment illustrated in FIG. 7.

FIG. 9 is an exploded view of the embodiment illustrated in FIG. 7.

FIG. 10 is a flowchart illustrating the operation of the embodiment illustrated in FIG. 7.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The present invention will now be described in detail with reference to embodiments thereof as illustrated in the accompanying drawings. In the following description, a direct current (DC) motor assembly will be discussed. Those of skill in the art will appreciate alternative labeling of the DC motor assembly as the assembly, apparatus, device, system, invention, or other similar names. Skilled readers should not view the inclusion of any alternative labels as limiting in any way.

Additionally, embodiments of this invention will be discussed in the context of being included in an electric fireplace. However, those of skill in the art will appreciate additional embodiments in which the present invention may be used to provide rotational motion to a device with the attributes that will be discussed below. Therefore, skilled artisans should not read any parts of the following disclosure to limit the present invention solely to applications within electric fireplaces.

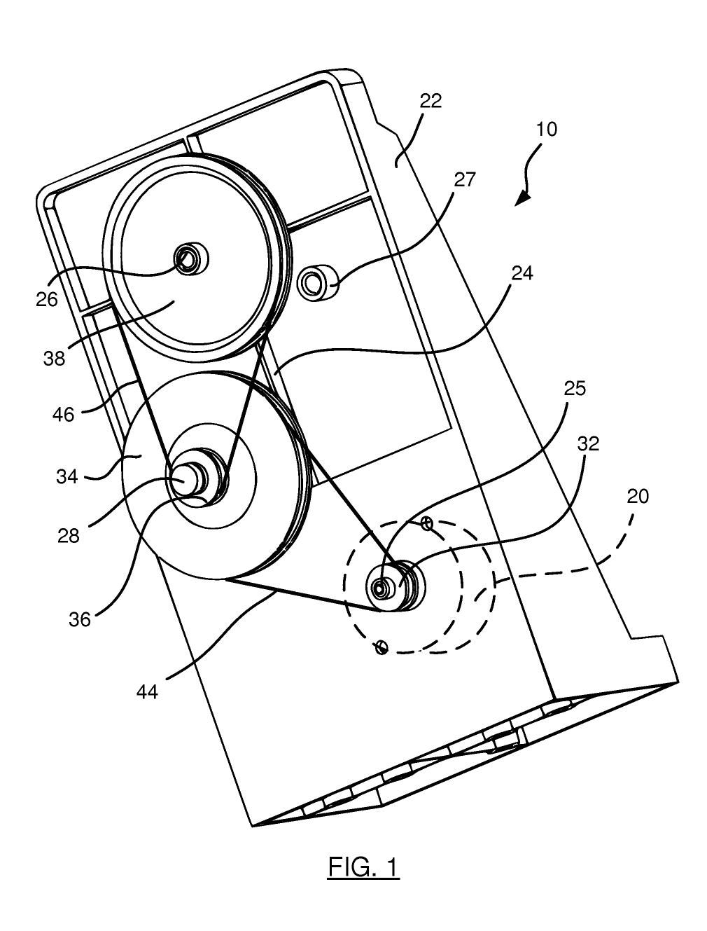

Referring now to FIG. 1, the DC motor assembly 10 will now be discussed. The assembly 10 may include a DC motor 20 and a transmission, which may be mounted or otherwise included on a bracket 22. The transmission may be used to convert an input rate of rotational motion to an output rate of rotational motion, which may be used to drive an auxiliary device. The transmission may include a number of pulleys, which may be interconnected via axles and belts. Additionally, the transmission may include gears, which may be interconnected by at least partially interlocking the teeth of the gears.

The bracket 22 will now be discussed in greater detail. The bracket 22 is configured to provide a place to secure the other parts of the assembly 10. The bracket 22 may be formed using a rigid material, such as metals, hardened plastics, or synthetic materials. However, skilled artisans will appreciate additional materials that could be used, which are intended to be included within the scope of this disclosure.

The various components of the assembly 10 may be mounted to the front and/or back of the bracket 22. By mounting the components on both the front and back of the bracket 22, the various components of the assembly 10 may be included in a compact and efficient space. As skilled artisans read the following example configurations, it should be noted that virtually any of the discussed components may be mounted on the front or the back of the bracket 22, and should not be limited to the configurations of the illustrative embodiments that follow.

A number of ports or holes may be drilled or formed in the bracket 22. Some of these holes may be used to mount the bracket 22 to another structure or surface, such as the interior of an electric fireplace. Other holes may be used to mount the various components to the bracket 22, such as the DC motor 20. Additional holes or ports may be provided to attach an axle to the bracket 22. The axles may optionally pass through the bracket 22 at the ports, communicating rotational motion received from one side of the bracket 22 to the other side of the bracket 22, such as rotational motion from the DC motor 20 being translated through the input axle 25 to the first pulley 32.

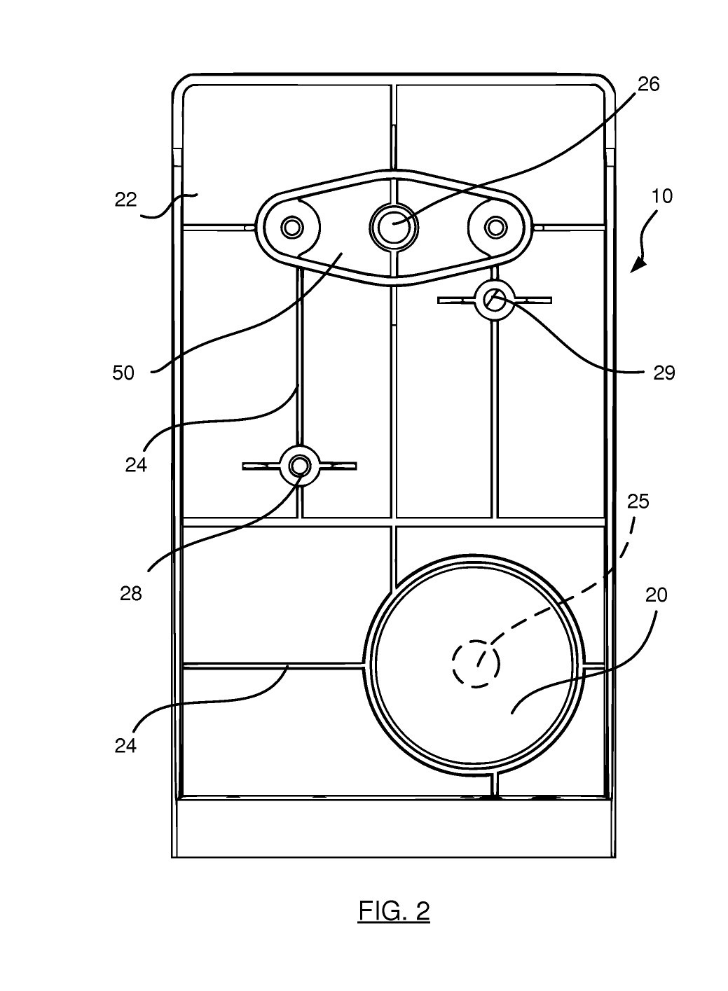

A specific example of a bracket 22 configuration will now be discussed. Skilled artisans should appreciate that the following example is provided in the interest of clarity, and is not intended to impose any limitation with respect to other embodiments of with differing layouts or dimensions. As illustrated in FIGS. 1-2, the bracket 22 may be approximately rectangular. The bracket 22 may be approximately 127 millimeters (mm) in height and 72 mm wide, with a depth that varies in proportion to the height. The bracket 22 may have a depth of approximately 43 mm near its base, which may taper to a lesser depth with an irregular pattern as the height ascends.

The bracket 22 may include mounting holes, which may be used to secure the bracket 22 to another structure or surface, such as a part of an electric fireplace. In a specific example, the four front mounting holes on the bottom of the bracket 22 may be located linearly at a depth of approximately 16 mm from the front of the bracket 22. The back mounting hole may be located at a depth of approximately 34 mm from the front of the bracket 22, being located at an approximate center point between the wide edges of the bracket 22 or approximately 36 mm in from each side. The two inner front mounting holes may be located approximately 12 mm from the center of the wide edges in both directions, with approximately 24 mm between the inner front mounting holes. Similarly, the outer front mounting holes may be located approximately 26 mm from the center of the wide edges in both directions, with approximately 52 mm between the outer front mounting holes.

Lengths of material 24, such as rigid plastic, may be included between the surfaces of the bracket 22 to provide additional strength and structural rigidity. These lengths of material 24 may include additional material configured to provide support and increased strength. Holes may be located along one or more of these lengths, which may help to secure an axle or mounting hardware. Additional holes may be included on the bracket 22 to provide for expansion or alternative configurations. For example, a second pulley axle 29 may be located at the expansion hole 27. Additionally, material may be removed or omitted from one or more portions of the bracket 22. Removal of the material from unnecessary portions may advantageously reduce the weight of the complete bracket 22 and decrease the amount of materials need for its formation.

A sleeve 50, shown in FIG. 2, may be located adjacent to the rear surface of the bracket 22. The sleeve 50 may be positioned such that the output axle 26 passes through a hole in the sleeve 50. The sleeve 50 may help to ensure the stability of the output axle 26 during operation of the motor 20 and transmission. An auxiliary axle may be connected to the output axle 26 at the sleeve 50 so that the rotational motion with the output rate may be used by an auxiliary device, such as a flame simulation mechanism within an electric fireplace.

As a specific example the assembly 10 may located in an electric fireplace. The electric DC motor 20 may be connected to a power source within the electric fireplace capable of supplying DC voltage. The output axle 26 may be connected an auxiliary axle, such as a component of a flame simulation mechanism in the electric fireplace. For example, extensions may be attached to the auxiliary axle that approximate the shape of flames. The extensions may be at least partially reflective. A light source, such as an array of LEDS, may illuminate a portion of the extensions, reflecting the part of the light from the light source to a screen. As the auxiliary axle and thus the extensions are rotated, the electric fireplace may simulate the visual appearance of a flickering flame to a user.

The DC motor 20 will now be discussed in greater detail, with the appreciation that the electrical and mechanical principles behind an electric motor will be known to a person of skill in the art. A DC motor is an electric motor that provides mechanical rotation using a direct current electrical power source. Using a permanent magnet, or as current may flow through a coiled wire, a magnetic field can be produced. A second magnetic field may also be created by the motor, which may interact with the first magnetic field. Since magnetic fields are attracted to opposite poles, and repelled by like poles, the magnetic fields may cause a rotor to rotate within the motor. By alternating the direction that current flows through the parts of the motor, depending on the configuration of the motor, the magnetic forces may continue to create rotational motion in a constant direction.

The DC motor may be brushed or brushless. A brushed DC motor includes communicators, which alternate the direction of current flow within the motor. For example, a brushed DC motor may alternate the direction in which current flows through a rotor that is located between stators using permanent magnets or coiled wiring. Alternatively, rotors of a brushless DC motor may include a rotating permanent magnet or soft magnetic core. DC electric current may be passed through the stator with varying directions. The direction of current flow may be controlled by a controller, which may alternate the flow of electric current. However, a DC motor with a controller to alternate the flow of current may differ from a AC motor in that the frequency of current alteration may be controlled with the DC brushless motor. Skilled artisans will appreciate the various compositions of DC motors, which are intended to be included within this disclosure.

DC motors provide numerous advantages over the AC counterparts. For example, the rate at which current may alternate its flow direction is not tied to a line frequency of the input power. As a result, DC motors are typically capable of operating at higher rates of rotational motion. Additionally, the rate at which DC motors create rotational motion is generally more controllable than with AC motors. Furthermore, DC motors are free from harmonics and reactive power consumption, allowing a DC motor to operate with high efficiency.

The transmission will now be discussed, along with reference to FIGS. 1-2. A transmission is a device that provides a controlled application of power or rotational motion. A transmission can convert a source of rotational motion with high speed and low torque characteristics into an output of rotational motion with a lower speed and increased torque characteristics.

The transmission of the present invention may include pulleys and belts. Two or more pulleys may be connected by a belt. Skilled artisans will understand ways in which a belt can be connected to a pulley, which are intended to be included within this disclosure. Belts and pulleys advantageously create little to negligible amounts of noise while in operation. In some embodiments, the transmission may also include gears. The gears may have interlocking teeth, by which one gear may turn another.

Example of specific embodiments will now be discussed. Skilled artisans will appreciate that although the following example is given in detail, it is not intended to limit the present invention in any way. Skilled artisans will appreciate additional configurations and variations consistent with the scope and spirit of the present invention, which are intended to be included by this disclosure.

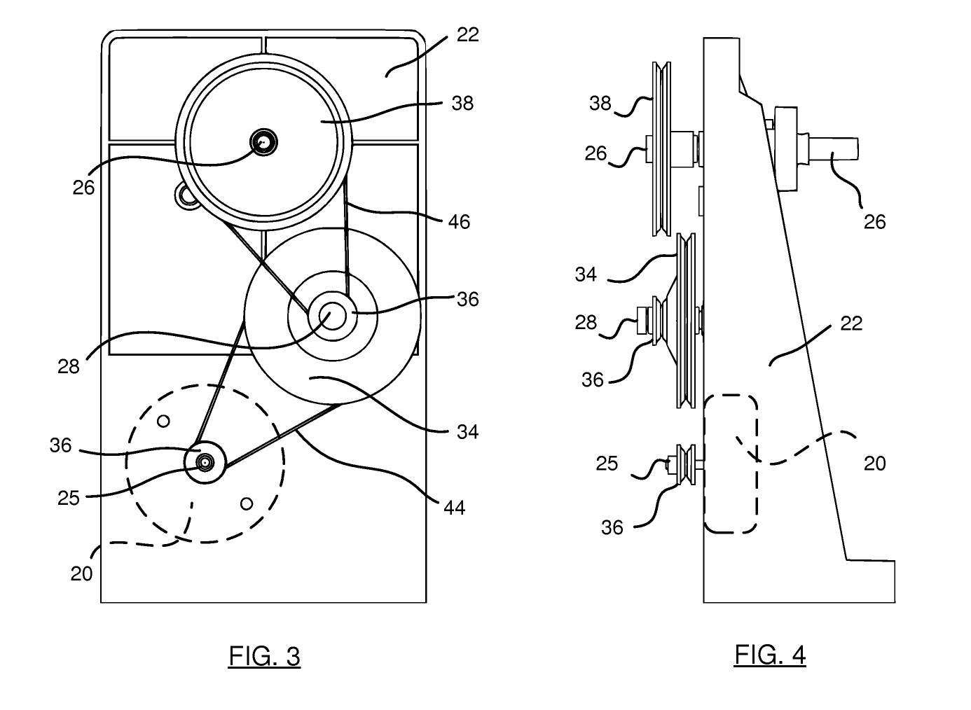

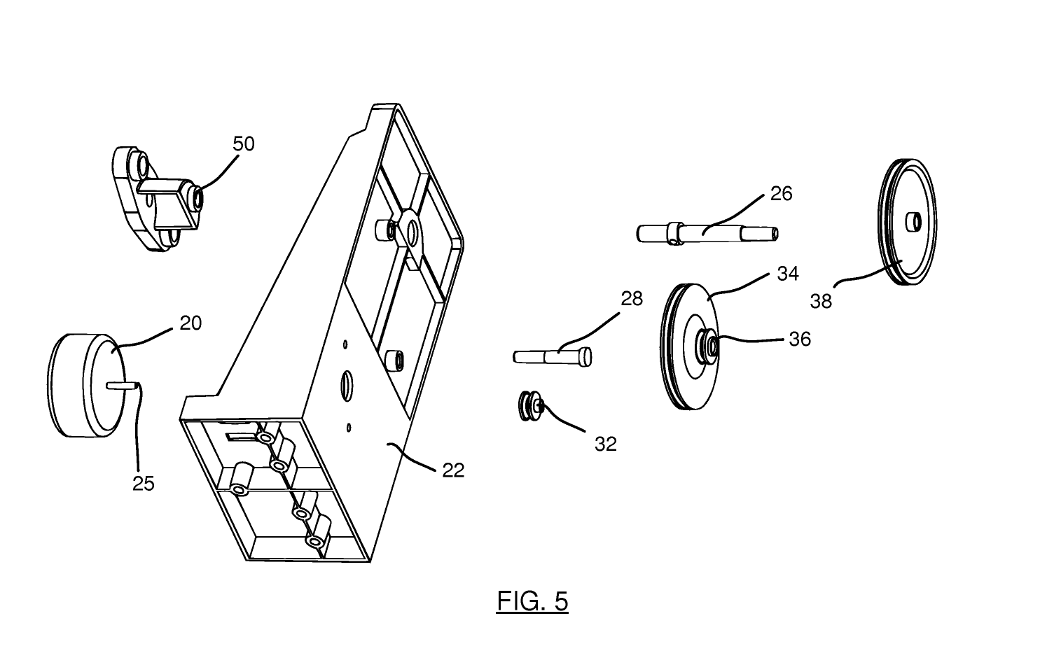

Referring now to FIGS. 3-5, along with FIGS. 1-2, an example of an assembly 10 with a transmission of pulleys will now be discussed. In this example, the DC motor 20 may be mounted to the rear surface of the bracket 22. The DC motor 20 may be attached to the bracket 22 via screws, rivets, adhesive, or otherwise held in place. An input axle 25 may extend outward from the face of the motor approximately orthogonally. The input axle 25 may have a first end located at the DC motor 20 and a second ended that is passed through the bracket 22. More specifically, the second end of the input axle 25 may pass through a hole in the bracket 22, where its second end may protrude through the front surface of the bracket 22 approximately orthogonally.

A first pulley 32 may be attached to the second end of the input axle 25 at the front of the bracket 22. More specifically, a first pulley 32 may have a hole in its center through which the second end of the input axle 25 may be inserted. The first pulley 32 may be secured to the second end of the input axle 25 such that the first pulley 32 rotates at the same rate as the DC motor 20 connected to the first end of the input axle 25. The first pulley 32 may be located at a first plane, located outward from the front surface of the bracket 22.

A first pulley axle 28 may also pass at least partially through the bracket 22, on which additional pulleys may be mounted. The first pulley axle 28 may be located a length away from the input axle 25 to provide sufficient space and distance between the input and first pulley axles 25, 28 to operate, for example, 43 mm. More specifically, a first end of the first pulley axle 28 may be at least partially passed through a hole in the bracket 22. The second end of the first pulley axle 28 may provide an elongated portion protruding away from the front surface of the bracket 22 approximately orthogonally. Optionally, the first pulley axle 28 may at least partially extend beyond the rear surface of the bracket 22 through which it is passed, protruding away from the rear surface of the bracket 22 approximately orthogonally. Alternatively, the first pulley axle 28 may only partially pass through the bracket 22, providing a first end of the first pulley axle 28 that is recessed from or flush with the rear surface of the bracket 22.

A second pulley 34 may be attached to the second end of the first pulley axle 28 at the front of the bracket 22. More specifically, the second pulley 34 may have a hole in its center through which the second end of the first pulley axle 28 may be inserted. The second pulley 34 may be positioned on the second end of the first pulley axle 28 such that it is aligned with the first pulley 32 on the first plane. The second pulley 34 may be secured to the second end of the first pulley axle 28 such that the second pulley 34 rotates at the same rate as the first pulley axle 28.

A third pulley 36 may be attached to the second end of the first pulley axle 28 at the front of the bracket 22. The third pulley 36 may have a different diameter than the second pulley 34, for example, a smaller diameter. The third pulley 36 may have a hole in its center through which the second end of the first pulley axle 28 may be inserted. The third pulley 36 may be positioned on the first pulley axle 28 such that it is located outwardly from the second pulley 34, with the third pulley 36 being on a second plane. The third pulley 36 may be secured to the second end of the first pulley axle 28 such that the third pulley 36 rotates at the same rate as the second pulley 34 also located on the first pulley axle 28.

Alternatively, the third pulley 36 may be fixedly attached to the second pulley 34. For example, the third pulley 36 may be secured to the second pulley 34 using hardware or adhesives. As another example, the second and third pulleys 34, 36 may be one single part that includes both pulleys.

An output axle 26 may also pass at least partially through the bracket 22, on which additional pulleys may be mounted. The output axle 26 may be located a length away from the first pulley axle 28 to provide sufficient space and distance between the first pulley and output axles 28, 26 to operate, for example, 41.5 mm. More specifically, a first end of the output axle 26 may be at least partially passed through a hole in the bracket 22. The second end of the output axle 26 may provide an elongated portion protruding away from the front surface of the bracket 22 approximately orthogonally. Additionally, the first end of the output axle 26 may at extend beyond the rear surface of the bracket 22 through which it is passed, protruding away from the rear surface of the bracket 22 approximately orthogonally. Optionally, the first end of the output axle 26 may pass through a sleeve 50, as discussed previously in this disclosure.

A fourth pulley 38 may be attached to the second end of the output axle 26 at the front of the bracket 22. More specifically, the fourth pulley 38 may have a hole in its center through which the second end of the output axle 26 may be inserted. The fourth pulley 38 may be positioned on the output axle 26 such that it is aligned with the third pulley 36 on the second plane. The fourth pulley 38 may be secured to the second end of the output axle 26 such that the fourth pulley 38 rotates at the same rate as the output axle 26.

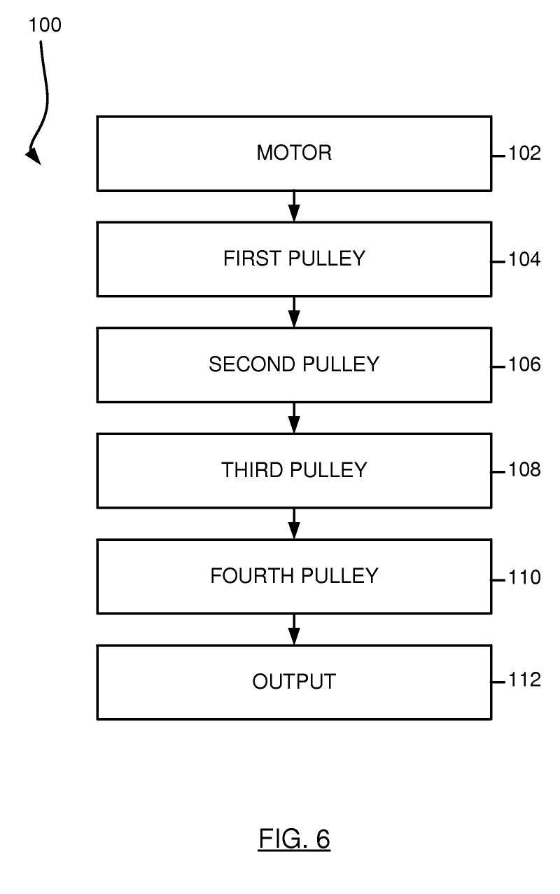

Referring now additionally to flowchart 100 of FIG. 6, the operation of this above example will now be discussed. The first and second pulleys 34 may be operatively connected via a first belt 44. Similarly, the third and fourth pulleys 38 may be connected via a second belt 46. Skilled artisans will appreciate the physical operation of a using a belt to drive pulleys.

As illustrated in flowchart 100, the motor may provide the initial rotational motion (Block 102). The input rate of rotational motion provided by the motor may be relative to the type of motor used, configuration of the motor, and voltage supplied to the motor. For example, a motor may be used with a variable input rate of rotational motion. The input rate may be varied in relation with the voltage supplied to the DC motor 20. For example, the motor may powered with voltages between 2 Vdc and 6 Vdc, which may correspond with input rates of between 360 and 1440 revolutions per minute (RPM) being generated by the DC motor 20. These high speed input rates may be stepped down using the transmission, as will be discussed along with Blocks 114-120 below.

In the embodiment illustrated in FIGS. 3-5, which are now discussed along with flowchart 100 of FIG. 6, the motor may be provided with a relatively low voltage, such as 3 Vdc. At this voltage, the motor may produce rotational motion at an input rate of approximately 360 RPM. The transmission may then step down the rotational motion with a ratio of about 1:20.

To convert the input rate of rotational motion to the output rate of rotational motion, the pulleys may be configured with various sizes to accomplish the desired conversion of the rate of rotational motion. As the DC motor 20 provides rotation the first end of the first pulley axle 28 at the input rate, the first pulley 32 attached to the second end of the first pulley axle 28 is rotated at the same input rate (Block 104). As mentioned above, the first pulley 32 may be connected to the second pulley 34 via the first belt 44 on the first plane. The second pulley 34 may have a larger diameter than the first pulley 32, resulting in the second pulley 34 rotating at a rate that is slower than the first pulley 32 (Block 106). Rotation of the second pulley 34 by the first belt 44 may cause the first pulley axle 28 to be rotated at the same rate of the second pulley 34, which may be slower than the rate of the input axle 25. Since the third pulley 36 is also connected to the first pulley axle 28, along with the second pulley 34, the third pulley 36 may be rotated at the same rate as the first pulley axle 28 and the second pulley 34 (Block 108). The third pulley 36 may have a smaller diameter than the second pulley 34.

The fourth pulley 38 may be connected to the third pulley 36 via the second belt 46 on the second plane. The fourth pulley 38 may have a larger diameter than the first pulley 32, resulting in the fourth pulley 38 rotating at a rate that is slower than the third pulley 36 (Block 110). Rotation of the fourth pulley 38 by the second belt 46 may cause the output axle 26 to be rotated at the same rate of the fourth pulley 38, which may be slower than the rate of the first pulley axle 28. Since the fourth pulley 38 is connected to the output axle 26, the fourth pulley 38 may be rotated at the output rate of rotational motion, which may be approximately 15-18 RPM (Block 112). Skilled artisans will appreciate that altering the voltage provided to the motor will alter the input rate of rotational motion, and thus the output rate of rotational motion to a rate other than approximately 15-18, without limitation.

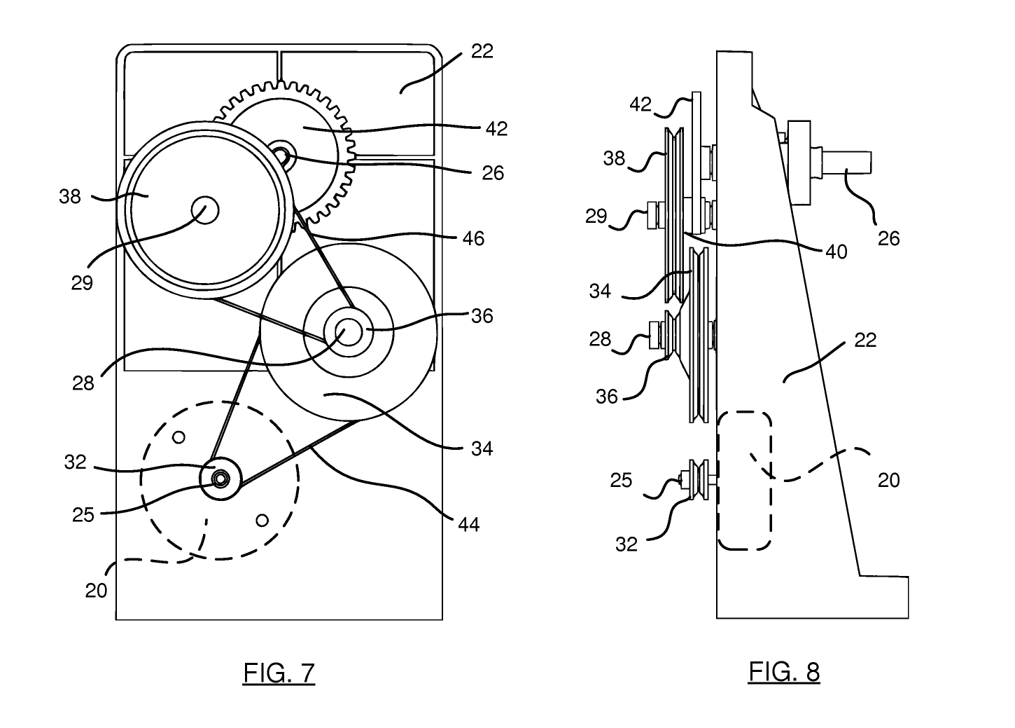

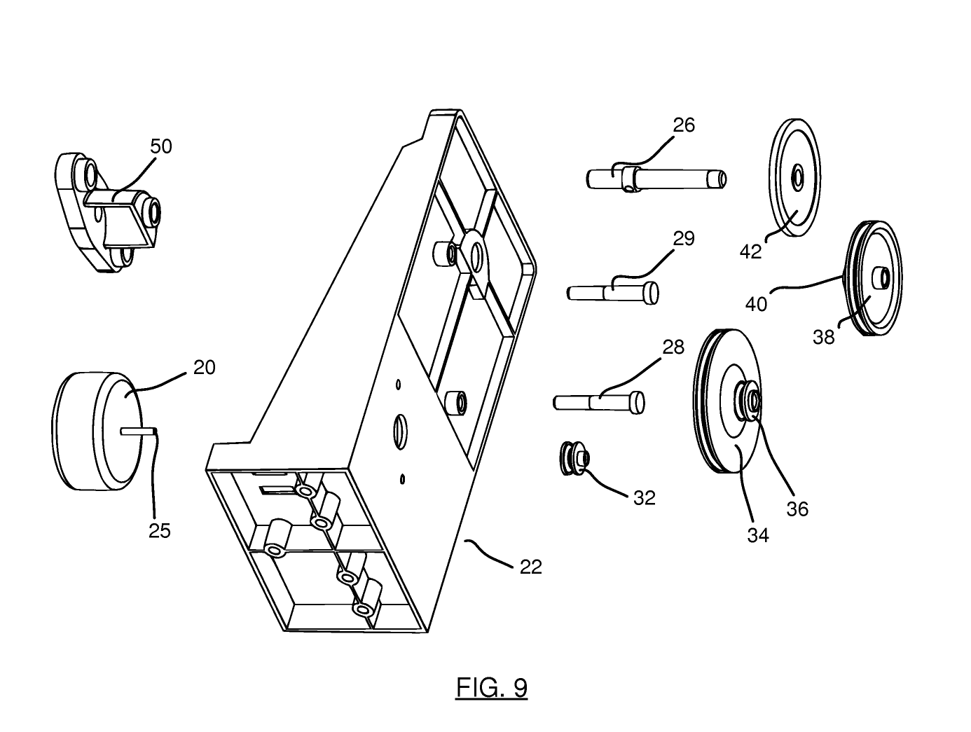

Referring now to FIGS. 7-9, an example of an alternative assembly 10 with a transmission of pulleys and gears will now be discussed. In this example, the DC motor 20 may be mounted to the rear surface of the bracket 22. The DC motor 20 may be attached to the bracket 22 via screws, rivets, adhesive, or otherwise held in place. An input axle 25 may extend outward from the face of the motor approximately orthogonally. The input axle 25 may have a first end located at the DC motor 20 and a second ended that is passed through the bracket 22. More specifically, the second end of the input axle 25 may pass through a hole in the bracket 22, where its second end may protrude through the front surface of the bracket 22 approximately orthogonally.

A first pulley 32 may be attached to the second end of the input axle 25 at the front of the bracket 22. More specifically, a first pulley 32 may have a hole in its center through which the second end of the input axle 25 may be inserted. The first pulley 32 may be secured to the second end of the input axle 25 such that the first pulley 32 rotates at the same rate as the DC motor 20 connected to the first end of the input axle 25. The first pulley 32 may be located at a first plane, located outward from the front surface of the bracket 22.

A first pulley axle 28 may also pass at least partially through the bracket 22, on which additional pulleys may be mounted. The first pulley axle 28 may be located a length away from the input axle 25 to provide sufficient space and distance between the input and first pulley axles 25, 28, for example, 43 mm. More specifically, a first end of the first pulley axle 28 may be at least partially passed through a hole in the bracket 22. The second end of the first pulley axle 28 may provide an elongated portion protruding away from the front surface of the bracket 22 approximately orthogonally. Optionally, the first pulley axle 28 may at least partially extend beyond the rear surface of the bracket 22 through which it is passed, protruding away from the rear surface of the bracket 22 approximately orthogonally. Alternatively, the first pulley axle 28 may only partially pass through the bracket 22, providing a first end of the first pulley axle 28 that is recessed from or flush with the rear surface of the bracket 22.

A second pulley 34 may be attached to the second end of the first pulley axle 28 at the front of the bracket 22. More specifically, the second pulley 34 may have a hole in its center through which the second end of the first pulley axle 28 may be inserted. The second pulley 34 may be positioned on the second end of the first pulley axle 28 such that it is aligned with the first pulley 32 on the first plane. The second pulley 34 may be secured to the second end of the first pulley axle 28 such that the second pulley 34 rotates at the same rate as the first pulley axle 28.

A third pulley 36 may be attached to the second end of the first pulley axle 28 at the front of the bracket 22. The third pulley 36 may have a different diameter than the second pulley 34, for example, a smaller diameter. The third pulley 36 may have a hole in its center through which the second end of the first pulley axle 28 may be inserted. The third pulley 36 may be positioned on the first pulley axle 28 such that it is located outwardly from the second pulley 34, with the third pulley 36 being on a second plane. The third pulley 36 may be secured to the second end of the first pulley axle 28 such that the third pulley 36 rotates at the same rate as the second pulley 34 also located on the first pulley axle 28.

Alternatively, the third pulley 36 may be fixedly attached to the second pulley 34. For example, the third pulley 36 may be secured to the second pulley 34 using hardware or adhesives. As another example, the second and third pulleys 34, 36 may be one single part that includes both pulleys.

A second pulley axle 29 may also pass at least partially through the bracket 22, on which additional pulleys may be mounted. The second pulley axle 29 may be located a length away from the first pulley axle 28 to provide sufficient space and distance between the first and second pulley axles 28, 29, for example, 41.5 mm. A first end of the second pulley axle 29 may be at least partially passed through a hole in the bracket 22. The second end of the second pulley axle 29 may provide an elongated portion protruding away from the front surface of the bracket 22 approximately orthogonally. Optionally, the second pulley axle 29 may at least partially extend beyond the rear surface of the bracket 22 through which it is passed, protruding away from the rear surface of the bracket 22 approximately orthogonally. Alternatively, the second pulley axle 29 may only partially pass through the bracket 22, providing a first end of the second pulley axle 29 that is recessed from or flush with the rear surface of the bracket 22.

A fourth pulley 38 may be attached to the second end of the second pulley axle 29 at the front of the bracket 22. More specifically, the fourth pulley 38 may have a hole in its center through which the second end of the second pulley axle 29 may be inserted. The fourth pulley 38 may be positioned on the second end of the second pulley axle 29 such that it is aligned with the third pulley 36 on the second plane. The fourth pulley 38 may be secured to the second end of the second pulley axle 29 such that the fourth pulley 38 rotates at the same rate as the second pulley axle 29.

A first gear 40 may be attached to the second end of the second pulley axle 29 at the front of the bracket 22. The first gear 40 may have a different diameter than the fourth pulley 38, for example, a smaller diameter. The first gear 40 may have a hole in its center through which the second end of the second pulley axle 29 may be inserted. The first gear 40 may be positioned on the second pulley axle 29 such that it is located inwardly from the fourth pulley 38, with the first gear 40 being on the first plane. The first gear 40 may be secured to the fourth end of the second pulley axle 29 such that the first gear 40 rotates at the same rate as the fourth pulley 38 also located on the second pulley axle 29.

Alternatively, the first gear 40 may be fixedly attached to the fourth pulley 38. For example, the first gear 40 may be secured to the fourth pulley 38 using hardware or adhesives. As another example, the fourth pulley 38 and first gear 40 may be one single part that includes both the pulley and the gear.

An output axle 26 may also pass at least partially through the bracket 22, on which additional pulleys or gears may be mounted. The output axle 26 may be located a length away from the second pulley axle 29 to provide sufficient space and distance between the second pulley and output axles 29, 26, for example, 20.15 mm. More specifically, a first end of the output axle 26 may be at least partially passed through a hole in the bracket 22. The second end of the output axle 26 may provide an elongated portion protruding away from the front surface of the bracket 22 approximately orthogonally. Additionally, the first end of the output axle 26 may at extend beyond the rear surface of the bracket 22 through which it is passed, protruding away from the rear surface of the bracket 22 approximately orthogonally. Optionally, the first end of the output axle 26 may pass through a sleeve 46, as discussed previously in this disclosure.

A second gear 42 may be attached to the second end of the output axle 26 at the front of the bracket 22. More specifically, the first gear 42 may have a hole in its center through which the second end of the output axle 26 may be inserted. The second gear 42 may be positioned on the output axle 26 such that it is aligned with the first gear 40 on the first plane. The second gear 42 may be secured to the second end of the output axle 26 such that the second gear 42 rotates at the same rate as the output axle 26.

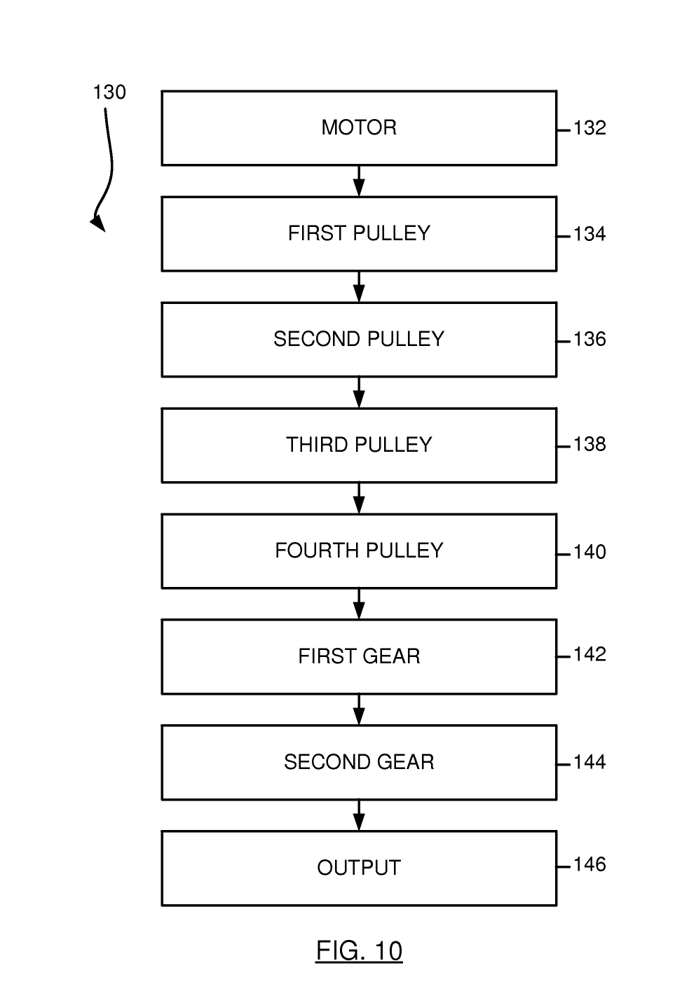

Referring now additionally to flowchart 130 of FIG. 10, the operation of this above example will now be discussed. The first and second pulleys 32, 34 may be operatively connected via a first belt 44. Similarly, the third and fourth pulleys 36,38 may be connected via a second belt 46. Skilled artisans will appreciate the physical operation of a using a belt to drive pulleys. Additionally, the first and second gears 40, 42 may be located adjacently such that the first gear 40 may drive the second gear 42.

As illustrated in flowchart 130, the motor may provide the initial rotational motion (Block 132). As with the last example, the input rate of rotational motion provided by the motor may be relative to the type of motor used, configuration of the motor, and voltage supplied to the motor. High speed input rates may be stepped down using the transmission, as will be discussed along with Blocks 134-144 below.

In the embodiment illustrated in FIGS. 7-9, which are now discussed along with flowchart 130 of FIG. 10, the motor may be provided with a relatively high voltage, such as 5-6 Vdc. At this voltage range, the motor may produce rotational motion at an input rate of approximately 1080-1440 RPM. The transmission may then step down the rotational motion with a ratio of about 1:60 or 1:80, respectively.

To convert the input rate of rotational motion to the output rate of rotational motion, the pulleys and gears may be configured with various sizes to accomplish the desired conversion of the rate. As the DC motor 20 provides rotation the first end of the first pulley axle 28 at the input rate, the first pulley 32 attached to the second end of the first pulley axle 28 is rotated at the same input rate (Block 134). As mentioned above, the first pulley 32 may be connected to the second pulley 34 via the first belt 44 on the first plane. The second pulley 34 may have a larger diameter than the first pulley 32, resulting in the second pulley 34 rotating at a rate that is slower than the first pulley 32 (Block 136). Rotation of the second pulley 34 by the first belt 44 may cause the first pulley axle 28 to be rotated at the same rate of the second pulley 34, which may be slower than the rate of the input axle 25. Since the third pulley 36 is also connected to the first pulley axle 28, along with the second pulley 34, the third pulley 36 may be rotated at the same rate as the first pulley axle 28 and the second pulley 34 (Block 138). The third pulley 36 may have a smaller diameter than the second pulley 34.

The fourth pulley 38 may be connected to the third pulley 36 via the second belt 46 on the second plane. The fourth pulley 38 may have a larger diameter than the first pulley 32, resulting in the fourth pulley 38 rotating at a rate that is slower than the third pulley 36 (Block 140). Rotation of the fourth pulley 38 by the second belt 46 may cause the second pulley axle 29 to be rotated at the same rate of the fourth pulley 38, which may be slower than the rate of the first pulley axle 28. Since the first gear 40 is also connected to the second pulley axle 29 along with the fourth pulley 38, the first gear 40 may be rotated at the same rate as the second pulley axle 29 and the fourth pulley 38 (Block 142). The first gear 40 may have a smaller diameter than the fourth pulley 38.

The first gear 40 may be connected to a second gear 42 attached to the output axle 26 via adjacently located gear teeth on the first plane. The second gear 42 may have a larger diameter than the first gear 40, resulting in the second gear 42 rotating at a rate that is slower than the first gear 40 (Block 144). Rotation of the second gear 42 by the first gear 40 may cause the output axle 26 to be rotated at the same rate of the second gear 42, which may be slower than the rate of the second pulley axle 29. Since the second gear 42 is connected to the output axle 26, the second gear 42 may be rotated at the output rate of rotational motion, which may be approximately 15-18 RPM (Block 146). Skilled artisans will appreciate that varying the voltage provided to the motor will alter the input rate of rotational motion, and thus the output rate of rotational motion to a rate other than approximately 15-18, without limitation.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An assembly includable in an electric fireplace for providing rotational motion comprising:
a direct current (DC) motor to create rotational motion about an input axle at an input rate, the DC motor being driven by an electric voltage that is variable; and
a transmission to convert the rotational motion from the input axle at the input rate to an output axle at an output rate, the transmission further comprising pulleys and a belt to convert the rotational motion from the input rate to the output rate;
wherein the motor and the transmission are operatively connected to a bracket.

2. The assembly of claim 1, wherein the bracket with the motor and the transmission is located in the electric fireplace, wherein an auxiliary axle is connected to the output axle to be rotated at the output rate, and wherein extensions are positioned about the auxiliary axle to simulate flames in the electric fireplace.

3. The assembly of claim 1, wherein the transmission further comprises:
a first pulley attached the input axle;
a second pulley attached to a first pulley axle, the second pulley having a larger diameter than the first pulley, wherein the second pulley is operatively connected to the first pulley via a first belt;
a third pulley attached to the first pulley axle, the third pulley having a smaller diameter than the second pulley; and
a fourth pulley attached to the output axle, the fourth pulley having a larger diameter than the third pulley, wherein the fourth pulley is operatively connected to the third pulley via a second belt.

4. The assembly of claim 1, wherein the transmission further comprises:
a first pulley attached the input axle;
a second pulley attached to a first pulley axle, the second pulley having a larger diameter than the first pulley, wherein the second pulley is operatively connected to the first pulley via a first belt;
a third pulley attached to the first pulley axle, the third pulley having a smaller diameter than the second pulley;
a fourth pulley attached to a second pulley axle, the fourth pulley having a larger diameter than the third pulley, wherein the fourth pulley is operatively connected to the third pulley via a second belt;
a first gear attached to the second pulley axle; and
a second gear attached to the output axle, the second gear having a larger diameter than the first gear, the second gear being operated by the first gear.

5. The assembly of claim 1, wherein the DC motor is driven by the electric voltage that is variable, wherein the variation of the electric voltage affects the input rate of the rotational motion that is converted by the transmission to the output rate.

6. An assembly includable in an electric fireplace for providing rotational motion comprising:
a direct current (DC) motor to create rotational motion about an input axle at an input rate, the DC motor being driven by an electric voltage that is variable; and
a transmission to convert the rotational motion from the input axle at the input rate to an output axle at an output rate, the transmission further comprising pulleys and a belt to convert the rotational motion from the input rate to the output rate;
wherein the variation of the electric voltage affecting the input rate of the rotational motion is converted by the transmission to the output rate.

7. The assembly of claim 6, wherein the motor and transmission are operatively connected to a bracket locatable in the electric fireplace, wherein the output axle is configured to receive and rotate an auxiliary axle at the output rate axle having extensions positioned about the auxiliary axle to simulate flames in the electric fireplace.

8. The assembly of claim 6, wherein the transmission further comprises:
a first pulley attached the input axle;
a second pulley attached to a first pulley axle, the second pulley having a larger diameter than the first pulley, wherein the second pulley is operatively connected to the first pulley via a first belt;
a third pulley attached to the first pulley axle, the third pulley having a smaller diameter than the second pulley; and
a fourth pulley attached to the output axle, the fourth pulley having a larger diameter than the third pulley, wherein the fourth pulley is operatively connected to the third pulley via a second belt.

9. The assembly of claim 6, wherein the transmission further comprises:
a first pulley attached the input axle;
a second pulley attached to a first pulley axle, the second pulley having a larger diameter than the first pulley, wherein the second pulley is operatively connected to the first pulley via a first belt;
a third pulley attached to the first pulley axle, the third pulley having a smaller diameter than the second pulley;
a fourth pulley attached to a second pulley axle, the fourth pulley having a larger diameter than the third pulley, wherein the fourth pulley is operatively connected to the third pulley via a second belt;
a first gear attached to the second pulley axle; and
a second gear attached to the output axle, the second gear having a larger diameter than the first gear, the second gear being operated by the first gear.

10. A method of providing rotational motion in an electric fireplace using a direct current (DC) motor and a transmission, the method comprising
(a) driving the DC motor with an electric voltage to create rotational motion about an input axle at an input rate, the electric voltage being is variable;
(b) converting the rotational motion from the input axle at the input rate to an output axle at an output rate using the transmission, wherein the transmission comprises pulleys and a belt to convert the rotational motion from the input rate to the output rate; and
wherein the motor and the transmission are operatively connected to a bracket locatable in the electric fireplace.

11. The method of claim 10, wherein the bracket with the motor and the transmission is located in the electric fireplace, further comprising after step (b) the steps of:
(c) rotating an auxiliary axle that is connected to the output axle at the output rate; and
(d) rotating extensions positioned about the auxiliary axle to simulate flames in the electric fireplace.

12. The method of claim 10, wherein step (b) further comprises the steps of:
(e) rotating a first pulley attached to the input axle;
(f) driving a first belt using the first pulley to rotate a second pulley attached to a first pulley axle, the second pulley having a larger diameter than the first pulley;
(g) rotating a third pulley attached to the first pulley axle, the third pulley having a smaller diameter than the second pulley;
(h) driving a second belt using the third pulley to rotate a fourth pulley attached to the output axle, the fourth pulley having a larger diameter than the third pulley.

13. The method of claim 10 wherein step (b) further comprises the steps of:
(i) rotating a first pulley attached the input axle;
(j) driving a first belt using the first pulley to rotate a second pulley attached to a first pulley axle, the second pulley having a larger diameter than the first pulley;
(k) rotating a third pulley attached to the first pulley axle, the third pulley having a smaller diameter than the second pulley;
(l) driving a second belt using the third pulley to rotate a fourth pulley attached to a second pulley axle, the fourth pulley having a larger diameter than the third pulley;
(m) rotating a first gear attached to the second pulley axle; and
(n) rotating a second gear attached to the output axle and operatively connected to the first gear, the second gear having a larger diameter than the first gear.

14. The method of claim 10, wherein the DC motor is driven by the electric voltage that is variable between approximately two volts and six volts, the variation of the electric voltage affecting the input rate of the rotational motion that is converted by the transmission to the output rate.
